(19) United States
(12) Patent Application Publication
(10) Pub. No.: US 2016/0223166 A1
(43) Pub. Date: Aug. 4, 2016

(54) LAMP WITH A MAIN LIGHT SOURCE AND ADDITIONAL LIGHT SOURCES

(71) Applicants: Wayne BENSON, NEWMARKET (CA); Varun CHANDAN, CALEDON (CA)

(72) Inventors: Wayne BENSON, NEWMARKET (CA); Varun CHANDAN, CALEDON (CA)

(21) Appl. No.: 15/013,388

(22) Filed: Feb. 2, 2016

Related U.S. Application Data
(60) Provisional application No. 62/110,858, filed on Feb. 2, 2015.

(51) Int. Cl. F21V 15/01

(52) U.S. Cl. CPC F21V 15/01; F21Y 2101/02; F21W 2131/205

(57) ABSTRACT

A lamp with at least one specific operational mode is disclosed herein. An endoscopy mode may be engineered to allow the lamp to create an even glow. The even glow may be seen to allow members of a surgical team to easily locate lamp during an endoscopy procedure. Furthermore, the even glow may be seen to provide limited brightness so that team members may more readily locate equipment in an otherwise dark operating room. Subsequent to location, the equipment may be relocated within the operating room.

### CROSS-REFERENCE TO RELATED APPLICATIONS

The present application claims priority to U.S. Provisional Patent Application No. 62/110,858, filed Feb. 2, 2015, the contents of which are hereby incorporated herein by reference.

### FIELD

The present application relates generally to a lamp and, more specifically, to a lamp with a main light source and additional light sources.

### BACKGROUND

An operating room, for instance, at a hospital, a surgery suite or a trauma center, is often nearly dark during an endoscopy procedure. Notably, the endoscopy procedure typically involves video monitor. Lower light power may be seen as beneficial to a team carrying out the endoscopy procedure. For example, lower light power may be seen to lead to decreased eye fatigue when compared to higher light power.

### BRIEF DESCRIPTION OF THE DRAWINGS

Reference will now be made, by way of example, to the accompanying drawings which show example implementations; and in which:

FIG. 1 illustrates an example lamp according to an aspect of the present application;

FIG. 2 illustrates a circuit board for use in the lamp of FIG. 1; and

FIG. 3 illustrates a surgical lamp assembly having a plurality of lamps of the sort of the lamp of FIG. 1, in accordance with an embodiment of the present application.

### DETAILED DESCRIPTION

A lamp with at least one specific operational mode is disclosed herein. An endoscopy mode may be engineered to create an even glow. The even glow may be seen to allow members of a surgical team to easily locate lamp during an endoscopy procedure. Furthermore, the even glow may be seen to provide limited brightness so that team members may more readily locate equipment in an otherwise dark operating room. Subsequent to location, the equipment may be relocated within the operating room.

According to an aspect of the present disclosure, there is provided a lamp comprising a housing and a circuit board housed within the housing. The circuit has a plurality of circuit paths, the circuit paths configured to provide electricity to: a main light source, positioned centrally on the circuit board; and a secondary light source, positioned peripherally on the circuit board.

Other aspects and features of the present disclosure will become apparent to those of ordinary skill in the art upon review of the following description of specific implementations of the disclosure in conjunction with the accompanying figures.

In overview, aspects of the present application relate to a surgical or diagnostic lamp having a specialized endoscopy mode for use in hospitals, surgery suites, trauma centers, etc.

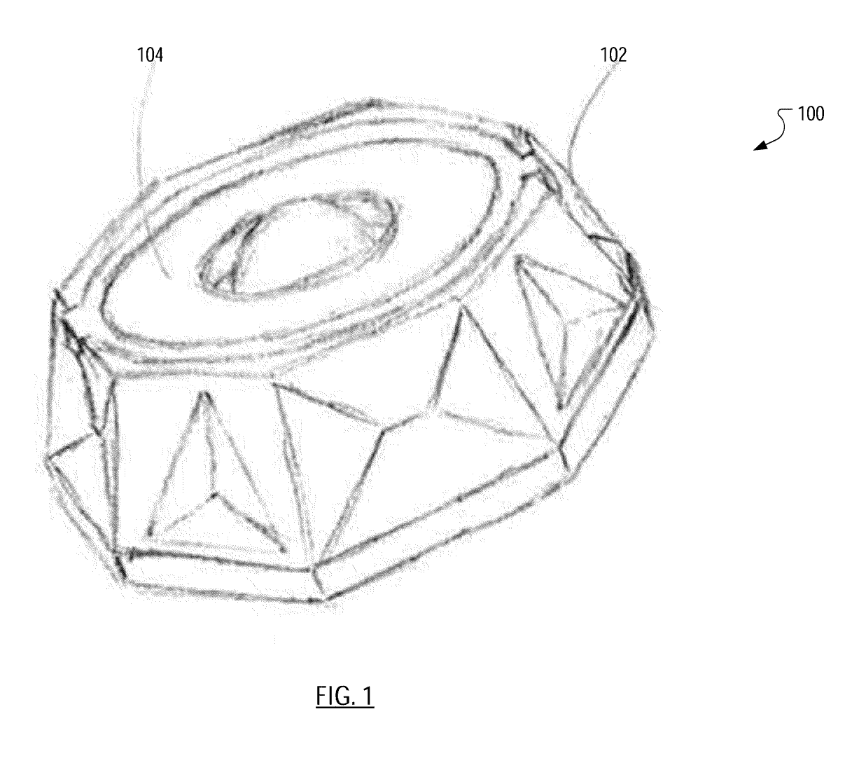

FIG. 1 illustrates an example lamp 100 according to an aspect of the present application. The lamp 100 of FIG. 1 includes a housing 102 and an optic 104. The housing 102 may be formed of acrylic material. Alternatively, the housing 102 may be formed of plastic.

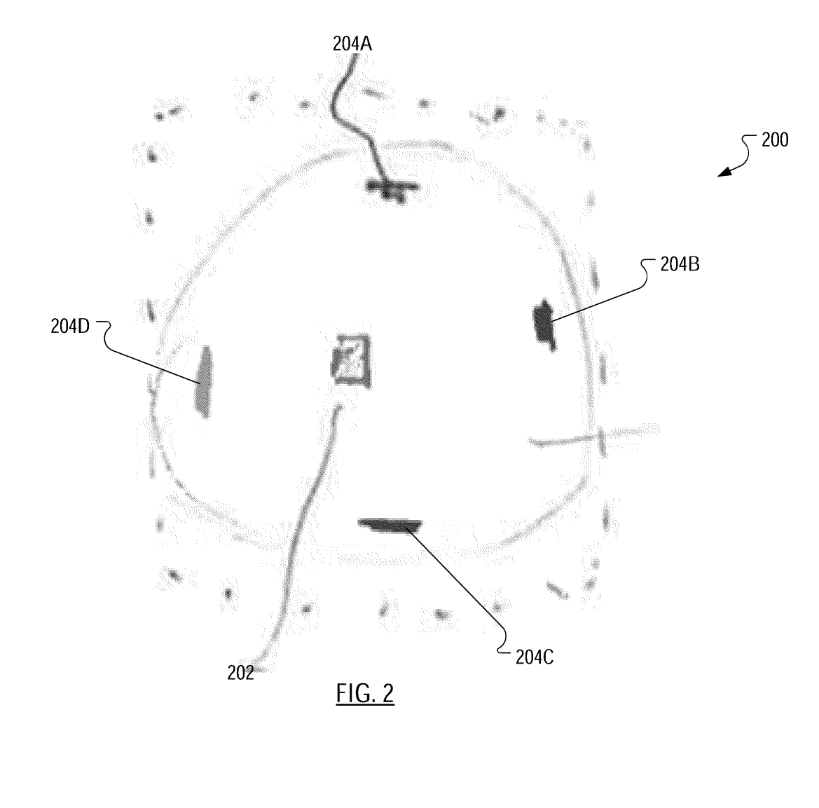

FIG. 2 illustrates a circuit board 200 for use in the lamp 100 of FIG. 1.

Central to the circuit board 200 is a primary, or “main,” light source 202. For example, the main light source 202 may be realized as a main Light Emitting Diode (LED) 202. Close to the periphery of the circuit board 200, multiple secondary, or “endo,” light sources 204 may be positioned. In the example circuit board 200 of FIG. 2, four endo LEDs 204 are positioned at approximately 90 degree intervals around the circular circuit board 200. The four endo LEDs 204 may be referenced as a first endo LED 204A, a second endo LED 204B, a third endo LED 204C and a fourth endo LED 204D.A main circuit path (not shown) is used to supply power to the main LED 202. A first endo circuit path (not shown) is used to supply power to the first endo LED 204A. A second endo circuit path (not shown) is used to supply power to the second endo LED 204B. A third endo circuit path (not shown) is used to supply power to the third LED endo 204C. A fourth endo circuit path (not shown) is used to supply power to the fourth endo LED 204D.

The main circuit path may be designed such that the main LED 202 is not affected by presence of the endo LEDs 204. Furthermore, each of the individual endo circuit paths may be designed so that each corresponding endo LED 204 is not affected by presence of the other endo LEDs 204.

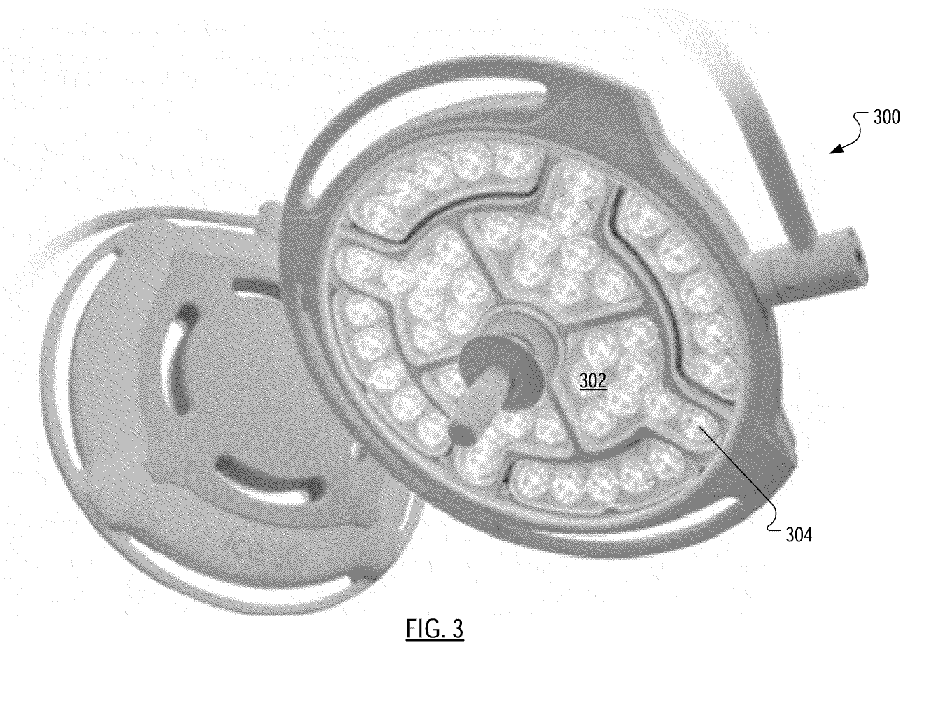

FIG. 3 illustrates a surgical lamp assembly 300 having a plurality of lamp collections 302. Mounted on each lamp collection 302 of the plurality of lamp collections 302 is a plurality of lamps 304. A circuit board may be included, as a component of the lamp collection 302. Notably, the circuit board of each lamp collection 302 may be designed with circuit paths to individual lamps 304 in a manner that prevents multiple lamps 304 from turning off responsive to damage to a circuit path leading to a particular lamp 304.

In operation, electric current is provided, via the main circuit path, to the main LED 202. Light from the main LED 202 may then be used for illuminating a patient. More particularly, light from the main LED 202 may then be used for illuminating a very specific portion of the patient. A lens (not shown) may be used to focus the light coming out of the main LED 202 onto the very specific portion of the patient. Indeed, the optic 104 may be used to focus the light coming out of the main LED 202 onto the very specific portion of the patient. The optic 104 may be a total internal refraction optic.

Electric current may also be provided, via the endo circuit paths, to the endo LEDs 204. Light from the endo LEDs 204 may then be used for creating an even glow. More particularly, the housing 102 may be used to bend the light from the endo LEDs 204 to create the even glow.

The housing 102 can also be used to align beam from a optic/reflector. For example, a parabolic shape for the housing 102 may be used with a reflective interior surface to reflect light from the main LED 202 to form a resultant beam of light emanating from the lamp 100.

Conveniently, the endo LEDs 204 may be designed so that minimal overhead is added to the overall design of the lamp 100. Furthermore, it may be shown that the addition of the endo LEDs 204 does not lead to the experience of any additional heat or color distortion from the perspective of the surgical team.

The above-described implementations of the present application are intended to be examples only. Alterations, modifications and variations may be effected to the particular implementations by those skilled in the art without departing from the scope of the application, which is defined by the claims appended hereto.

What is claimed is:

1. A lamp comprising:
a housing; and
a circuit board housed within the housing, the circuit having a plurality of circuit paths, the circuit paths configured to provide electricity to:
a main light source, positioned centrally on the circuit board; and
a secondary light source, positioned peripherally on the circuit board.

2. The lamp of claim 1 wherein the main light source comprises a light emitting diode.

3. The lamp of claim 1 wherein the secondary light source comprises a light emitting diode.

4. The lamp of claim 1 wherein the housing comprises an acrylic material.

5. The lamp of claim 1 wherein the housing comprises a plastic.
